(19) United States
(12) Patent Application Publication
(10) Pub. No.: US 2015/0315488 A1
(43) Pub. Date: Nov. 5, 2015

(54) METHODS AND SYSTEMS FOR IMPROVING LIQUID YIELDS AND COKE MORPHOLOGY FROM A COKER

(71) Applicants: Patrick Loring HANKS, Bridgewater, NJ (US); Brenda A. RAICH, Annandale, NJ (US)

(72) Inventors: Patrick Loring HANKS, Bridgewater, NJ (US); Brenda A. RAICH, Annandale, NJ (US)

(73) Assignee: ExxonMobil Research and Engineering Company, Annandale, NJ (US)

(21) Appl. No.: 14/691,882

(22) Filed: Apr. 21, 2015

Related U.S. Application Data
(60) Provisional application No. 61/986,964, filed on May 1, 2014.

(51) Int. Cl. C10G 51/02; B01J 19/24; C10J 3/46; C10G 57/02; C10G 69/06; C10G 69/12; B01J 8/24; C10G 55/04

(52) U.S. Cl. CPC C10G 51/02; B01J 8/24; B01J 19/245; C10G 55/04; C10G 57/02; C10G 69/06; C10G 69/126; C10J 3/466; B01J 2208/00893; B01J 2219/24; C10J 2300/0943; C10J 2300/0976; C10J 2300/0956; C10J 2300/1207; C10J 2300/1838

(57) ABSTRACT

Systems and methods of coking are provided that crack feeds and/or products of the coker to improve liquid yields and/or increase the Conradson carbon residue of the hydrocarbon feed to the coker.

### CROSS-REFERENCE TO RELATED APPLICATION

The present application claims priority to U.S. Patent Application Ser. No. 61/986,964, filed May 1, 2014.

### FIELD

The present invention relates to a method and system for improving liquid yields from a coker. More specifically, the present invention relates to methods and systems of improving liquid yield from a coker utilizing hydrodynamic cavitation.

### BACKGROUND

Cokers are utilized to convert residual oils from atmospheric and vacuum distillation columns into lighter hydrocarbons such as naphtha and gas oils by thermally cracking hydrocarbon molecules in the residual oils. The remaining carbon is recovered in the form of petroleum coke.

Generally, when cost effective, it is desirable to improve liquid yields from cokers. In addition, it is generally desirable to produce coke products with desired morphology. Accordingly, it would be advantageous to provide improvements to coking processes that allow for the realization of improved liquid yields and improvements in coke morphology.

### SUMMARY

The present invention addresses these and other problems by providing systems and methods of coking that crack feeds and/or products of the coker to improve liquid yields and/or increase the Conradson carbon residue (CCR) of the hydrocarbon feed to the coker.

In one aspect, a method of coking is provided that comprises subjecting a hydrocarbon feed to hydrodynamic cavitation to crack at least a portion of the hydrocarbon molecules present in the hydrocarbon feed and thereby produce a cavitated hydrocarbon feed; and feeding at least a portion of the cavitated hydrocarbon feed to a coker.

In another aspect, a system for coking a hydrocarbon feed is provided that comprises a hydrodynamic cavitation unit adapted to receive a hydrocarbon feed and subject the hydrocarbon feed to hydrodynamic cavitation to crack at least a portion of the hydrocarbon molecules present in the hydrocarbon feed and thereby produce a cavitated hydrocarbon feed; and a coker downstream of the hydrodynamic cavitation unit configured to receive at least a portion of the cavitated hydrocarbon feed.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for improving the liquid yield from a coker according to one or more embodiments of the present invention.

FIG. 3 is a flow diagram of a system for improving the liquid yield from a coker according to one or more embodiments of the present invention.

FIG. 4 is a flow diagram of a system for improving the liquid yield from a coker according to one or more embodiments of the present invention.

### DETAILED DESCRIPTION

Systems and methods are disclosed herein that are useful for improving the liquid yield from cokers. The systems and methods may also be used to produce petroleum coke with desirable morphology. Advantageously, these and other benefits may be realized in a cost effective manner allowing for increased coker margin.

The systems and methods utilize a hydrodynamic cavitation unit to receive a hydrocarbon feed such as a resid feed, or a cut thereof, upstream of the coker and subject the resid feed to conditions suitable to hydrodynamically cavitate the resid feed and thereby crack at least a portion of the hydrocarbon molecules in the residue feed. The cavitated resid feed may then be fed to the coker.

The systems and methods may be utilized with various types of cokers including delayed coking, FLUID COKING™, and FLEXICOKING™ processes. For clarity, the following description focuses primarily on the implementation of the methods and systems with delayed cokers, but it should be appreciated that the principles of the described methods are also applicable to FLUID COKING™ units, including those cokers operating the FLEXICOKING™ coking processes. Variation of the methods as implemented with fluid cokers will be briefly discussed.

The systems and methods may be utilized with various hydrocarbon feeds, including hydrocarbon feeds comprising at least 50 wt % or at least 80 wt % residual oil, such as residual oil feeds from the atmospheric or vacuum distillation columns or coker fractionator bottoms, or a combination thereof. Preferably the hydrocarbon feed has a T95 boiling point (the temperature at which 95 wt % of the material boils off at atmospheric pressure) of 1000° F. or greater, or 1500° F. or greater. The hydrocarbon feed may have a T5 boiling point (the temperature at which 5 wt % of the material boils off at atmospheric pressure of at least 600° F., or at least 800° F.

Generally the methods of the present invention may include subjecting a hydrocarbon feed, such as a residual oil feed, to hydrodynamic cavitation to crack at least a portion of the hydrocarbon molecules present in the residual oil feed and thereby produce a cavitated residual oil feed; and feeding at least a portion of the cavitated residual oil feed to a coker. The cavitated residual oil feed may be fed to a coker through a coker furnace or may be first fed to a coker product fractionation for fractionation with the coker product. The residual oil feed may be vacuum resid or atmospheric resid. In any embodiment, the residual oil feed may be the bottoms from the coker product fractionator. In fluid coker embodiments, the cavitated residual oil feed may be fed to the coker through the scrubber.

The systems of the present invention may include a hydrodynamic cavitation unit adapted to receive a feed of residual oil and subject the residual oil to hydrodynamic cavitation to crack at least a portion of the hydrocarbon molecules present in the residual oil feed and thereby produce a cavited residual oil feed; and a coker downstream of the hydrodynamic cavitation unit configured to receive at least a portion of the cavitated residual oil feed. The system may include a coker product fractionator which receives the cracked product from the coker and separates the cracked product into useful product streams, such as a naphtha stream, a light gas oil stream, and a heavy gas oil stream. In any embodiment, the cavitated residual oil feed may be first fed to the fractionator where it is allowed to mix with the cracked coker product and fractionate. The bottoms of the fractionator may then fed to the coker.

In any embodiment, 1 to 35 wt % of a 1050+° F. boiling point fraction of the hydrocarbon feed may be converted to lower molecular weight hydrocarbons. For example, 1 to 30 wt %, or 1 to 25 wt %, or 1 to 20 wt %, or 1 to 15 wt %, or 1 to 10 wt % of the hydrocarbons in the 1050+° F. boiling point fraction may be converted.

In any embodiment, when subjected to hydrodynamic cavitation, the hydrocarbon feed may be subjected to a pressure drop of at least 400 psig, or a pressure drop greater than 1000 psig, or a pressure drop greater than 2000 psig. In any embodiment, the hydrodynamic cavitation may be performed in the absence of a catalyst. Furthermore, in any embodiment the hydrodynamic cavitation is performed in the absence of a hydrogen containing gas or wherein hydrogen containing gas is present in the hydrocarbon feed at less than 50 standard cubic feet per barrel. Furthermore, in any embodiment, the hydrodynamic cavitation is performed in the absence of a diluent oil.

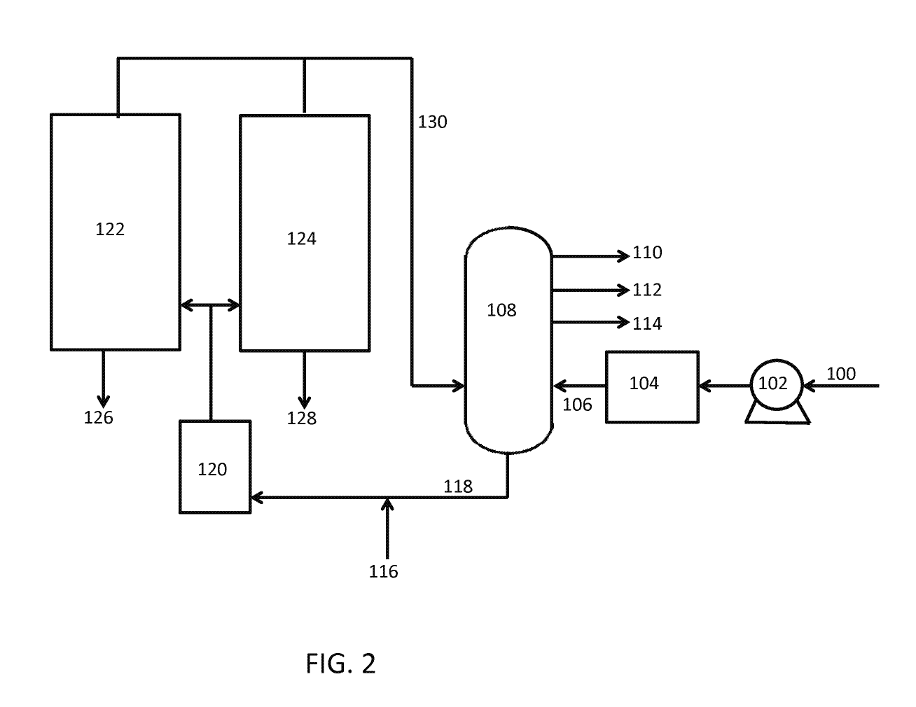

An exemplary embodiment of the present invention is illustrated in FIG. 2. In the illustrated embodiment a resid feed 100, which may be any of the residual oil feeds described herein, is fed to a hydrodynamic cavitation unit 104 by a pump 102 under conditions suitable for hydrodynamically cavitating the resid feed 100, and thereby cracking at least a portion of the hydrocarbon molecules in the resid feed 100. Specific aspects of such conditions and the hydrodynamic cavitation unit 104 are described in greater detail subsequently. The cavitated feed stream 106 is then fed to the coker product fractionator 108 where it is allowed to mix with cracked products from the cokers 122 and 124. The bottoms stream 118 from the fractionator 108 is mixed with steam 116 and then heated in the coker furnace 120 before being fed to the coking drums 122 and 124. Within the coking drums 122 and 124 the residual oil is thermally cracked. The smaller molecules produced in the cokers 122 and 124 are fed via cracked stream 130 to the fractionator where they are fractionated into useful product fraction streams including naphtha 110, light gas oil 112 and heavy gas oil 114. The remaining carbon material from the coking drums 122 and 124 is withdrawn in the form of coke as 126 and 128.

By feeding the cavitated feed stream 106 to the fractionator 108 first, lower boiling point fractions formed by cavitation are allowed to recovered in the appropriate product fraction rather than being fed to the cokers 122 and 124. The cavitated bottoms 118 are reduced in volume (relative to an alternative approach where hydrodynamic cavitation unit 104 is omitted), so the duty of coker furnace 120 is reduced. This process may lead to higher CCR, as measured by ASTM D4530, which can advantageously enable formation of shot coke rather than transition or sponge coke.

Although not illustrated specifically in FIG. 2, it should be noted that in any embodiment the cavitated feed stream 106 may be fed to the fractionator 108 at an injection location that is above the injection location of cracked stream 130 from the coker. Such an injection scheme may increase the total liquid yields recovered from the cavitated feed stream 106.

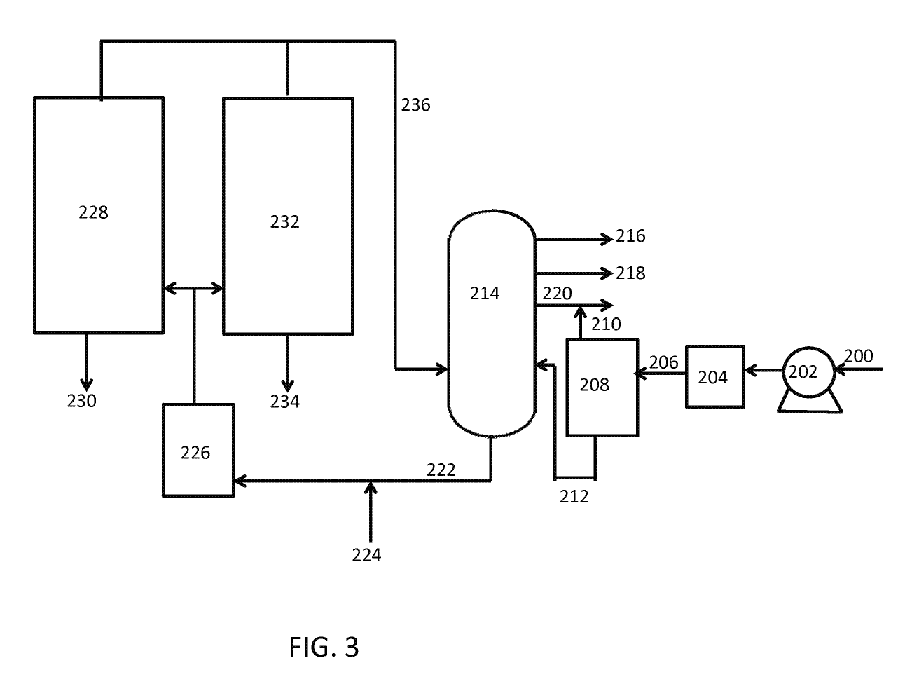

Another embodiment is illustrated in FIG. 3. In the illustrated embodiment, a resid feed 200 is fed to a hydrodynamic cavitation unit 204 by a pump 202 under conditions suitable for hydrodynamically cavitating the resid feed 200, and thereby cracking at least a portion of the hydrocarbon molecules in the resid feed 200. Specific aspects of such conditions and the hydrodynamic cavitation unit 204 are described in greater detail subsequently. The cavitated feed stream 206 is then fed to a separator 208, such as a flash drum, before the liquid cavitated product 212 is fed to the coker product fractionator 214 where it is allowed to mix with cracked products from the coking drums 228 and 232. The vapor phase 210 from separator 208 may be blended with heavy gas oil product stream 220. In an alternative embodiment, separator 208 may be a single stage flash unit, and vapor phase 210 may be sent to the product fractionator 214 and the liquid phase from the separator 208 may be sent directly to the coking drums 228 and 232 bypassing the product fractionator 214.

The bottoms stream 222 from the fractionator 214 is mixed with steam 224 and then heated in the coker furnace 226 before being fed to the coking drums 228 and 232. Within the coking drums 228 and 232 the residual oil is thermally cracked. The smaller molecules produced in the coking drums 228 and 232 are fed via cracked stream 236 to the fractionator 214 where they are fractionated into useful product fraction streams including naphtha 216, light gas oil 218 and heavy gas oil 220. The remaining carbon material from the coking drums 228 and 232 is withdrawn in the form of coke 230 and 234.

By removing lighter material ahead of fractionator 214 with separator 208, a hydraulic constraint of an existing fractionator (in the case of a retrofit) may be avoided.

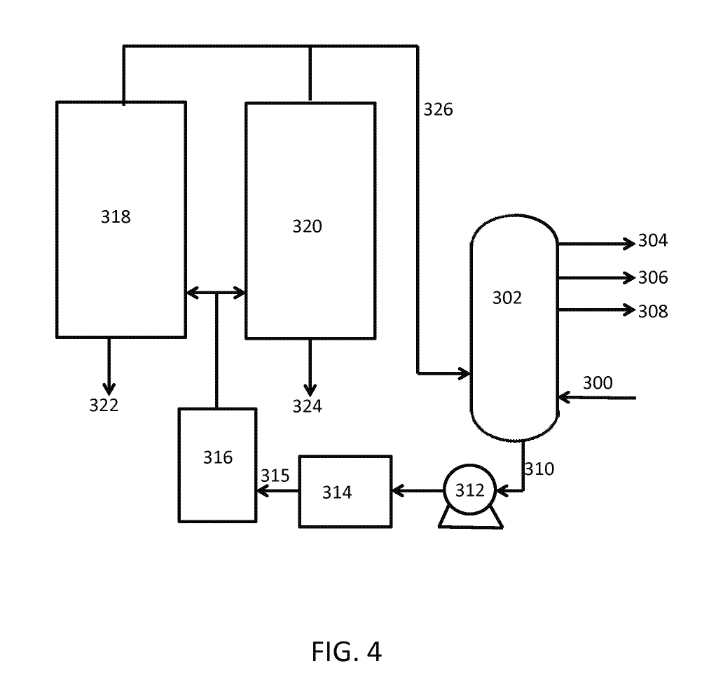

Yet another embodiment is illustrated in FIG. 4. In the illustrated embodiment, resid feed 300 is fed to the coker product fractionator 302 where it is allowed to mix with cracked products from the coking drums 318 and 320. The bottoms stream 310 from the fractionator 302 is then fed to a hydrodynamic cavitation unit 314 by a pump 312 under conditions suitable for hydrodynamically cavitating the bottoms stream 310, and thereby cracking at least a portion of the hydrocarbon molecules in the bottoms stream 310. Optionally, a flash drum may be employed upstream of the furnace to allow lighter material to bypass the coker and the lighter material may be fed directly to the coker effluent line or to the fractionator. The cracked bottoms 315 are then heated in the coker furnace 316 before being fed to the coking drums 318 and 320. Within the coking drums 318 and 320 the residual oil is thermally cracked. The smaller molecules produced in the coking drums 318 and 320 are fed via cracked stream 326 to the fractionator 302 where they are fractionated into useful product fraction streams including naphtha 304, light gas oil 306 and heavy gas oil 308. The remaining carbon material from the coking drums 318 and 320 is withdrawn in the form of coke 322 and 324.

In an embodiment with a Fluid Coking unit, a residual oil feed may be fed to a hydrodynamic cavitation unit where the residual oil is subjected to conditions suitable for hydrodynamically cavitating the residual oil stream and at least a portion of the hydrocarbons are cracked into smaller molecules. The cavitated residual oil may then be fed to a scrubber section of the Fluid Coking unit where lower boiling point material is separated and the remaining residual oil is processed by the reactor section of the fluid coker.

In another embodiment with a Fluid Coking unit, the cracked residual oil may be injected directly into the reactor portion of the coker instead of the scrubber upstream of the reactor. Such a method may change the hydrodynamic behavior of the Fluid Coking unit in beneficial ways. For example, resid feed may normally be sprayed into the fluidized bed of the reactor at 550-700° F. For some vacuum resids, this will correspond to a kinematic viscosity of 2.34-1.24 cSt. The cavitated resid viscosity range would be 1.55 to 0.94 cSt (viscosity extrapolated using ASTM D341). The lower viscosity may enable a smaller droplet size, assuming constant pressure drop through the nozzle and constant temperature. The smaller droplets result in thinner films of the resid on the coke. This is predicted to improve the liquid yield of the coker. Liquid yield is defined as the recovered weight of molecules with 5 carbons or more that are recovered from the process divided by the total weight of fresh feed to the process. Liquid yield may be improved by 1 wt %, 2 wt %, 5 wt %, or even 15 wt % on a fresh feed basis.

In addition to the improved liquid yields from cokers, improved coke morphology from delayed cokers is also predicted. As illustrated in the examples, cavitation of bitumen and resid increases the CCR and n-heptane insolubles of the material. Higher n-heptane insolubles/CCR ratio values in coker feeds correlates with formation of shot coke rather than transition or sponge coke. Thus, cavitation, particularly of residual oil feeds having initially low CCR values, is expected to improve the morphology of petroleum coke made from the cavitated feed.

### Delayed Coking

Delayed coking involves thermal decomposition of petroleum residua (resids) to produce gas, liquid streams of various boiling ranges, and coke. Delayed coking of resids from heavy and heavy sour (high sulfur) crude oils is carried out primarily as a means of disposing of these low value resids by converting part of the resids to more valuable liquid and gaseous products, and leaving a solid coke product residue. Although the resulting coke product is generally thought of as a low value by-product, it may have some value, depending on its grade, as a fuel (fuel grade coke), electrodes for aluminum manufacture (anode grade coke), etc.

In a conventional (i.e., known to those skilled in the art of hydrocarbon thermal conversion) delayed coking process, the feedstock is rapidly heated in a fired heater or tubular furnace. The heated feedstock is then passed to a large steel vessel, commonly known as a coking drum that is maintained at conditions under which coking occurs, generally at temperatures above about 400° C. under super-atmospheric pressures. The feed (e.g., a heavy hydrocarbon such as resid) in the coker drum generates volatile components that are removed overhead and passed to a fractionator, ultimately leaving coke behind. When the first coker drum is full of coke, the heated feed is switched to a “sister” drum and hydrocarbon vapors are purged from the drum with steam. The drum is then quenched by first flowing steam through the drum and then by filling the drum with water to lower the temperature to less than about 100° C. after which the water is drained. The draining is usually done back through the inlet line. When the cooling and draining steps are complete, the drum is opened (i.e., the top and bottom heads are removed from the drum) and the coke is removed by drilling and/or cutting using, e.g., high velocity water jets.

Embodiments of delayed cokers are described in greater detail in U.S. Pat. No. 7,914,668, which is incorporated by reference herein in its entirety.

### Fluid Coking

Fluidized bed coking (fluid coking) is a petroleum refining process in which heavy petroleum feeds, typically the non-distillable residue (resid) from fractionation, are converted to lighter, more useful products by thermal decomposition (coking) at elevated reaction temperatures, typically about 480 to 590° C., (about 900 to 1100° F.). The process is carried out in a unit with a large reactor vessel containing hot coke particles which are maintained in the fluidized condition at the required reaction temperature with steam injected at the bottom of the vessel.

The heavy oil feed is heated to a pumpable temperature, mixed with atomizing steam, and fed through a number of feed nozzles to the reactor. The steam injected at the bottom of the reactor into the stripper section passes upwards through the coke particles in the stripper as they descend from the main part of the reactor above. A part of the feed liquid coats the coke particles and subsequently decomposes into layers of solid coke and lighter products which evolve as gas or vaporized liquid.

The light hydrocarbon products of the coking reaction vaporize, mix with the fluidizing steam and pass upwardly through the fluidized bed into a dilute phase zone above the dense fluidized bed of coke particles. This mixture of vaporized hydrocarbon products formed in the coking reactions continues to flow upwardly through the dilute phase with the steam at superficial velocities of about 1 to 2 metres per second (about 3 to 6 feet per second), entraining some fine solid particles of coke.

Most of the entrained solids are separated from the gas phase by centrifugal force in one or more cyclone separators, and are returned to the dense fluidized bed by gravity through the cyclone diplegs. The mixture of steam and hydrocarbon vapor from the reactor is subsequently discharged from the cyclone outlets and quenched by contact with liquid descending over scrubber sheds in a scrubber section. A pumparound loop circulates condensed liquid to an external cooler and back to the top row of scrubber section to provide cooling for the quench and condensation of the heaviest fraction of the liquid product. This heavy fraction is typically recycled to extinction by feeding back to the fluidized bed reaction zone.

The solid coke from the reactor, consisting mainly of carbon with lesser amounts of hydrogen, sulfur, nitrogen, and traces of vanadium, nickel, iron, and other elements derived from the feed, passes through the stripper and out of the reactor vessel to a heater where it is partly burned in a fluidized bed with air to raise its temperature from about 480 to 700° C. (about 900° to 1300° F.), after which the hot coke particles are recirculated to the fluidized bed reaction zone to provide the heat for the coking reactions and to act as nuclei for the coke formation.

The FLEXICOKING™ process, developed by Exxon Research and Engineering Company, is, in fact, a fluid coking process that is operated in a unit including a reactor and heater as described above but also including a gasifier for gasifying the coke product by reaction with an air/steam mixture to form a low heating value fuel gas. The heater, in this case, is operated with an oxygen depleted environment. The gasifier product gas, containing entrained coke particles, is returned to the heater to provide a portion of the reactor heat requirement. A return stream of coke sent from the gasifier to the heater provides the remainder of the heat requirement. Hot coke gas leaving the heater is used to generate high-pressure steam before being processed for cleanup. The coke product is continuously removed from the reactor. In view of the similarity between the FLEXICOKING™ process and the fluid coking process, the term “fluid coking” is used in this specification to refer to and comprehend both fluid coking and cokers operating with the FLEXICOKING™ process.

Embodiments of fluid cokers are described in WO 2011/056628 A2, which is incorporated by reference herein in its entirety.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

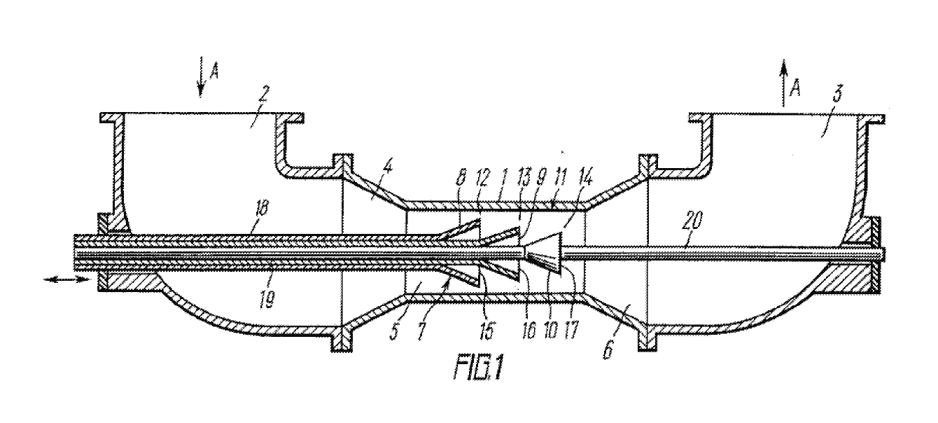

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing 1 having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (ie, thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

### Specific Embodiments

To further illustrate different aspects of the present invention, the following specific embodiments are provided:

Paragraph A—A method of coking comprising: subjecting a hydrocarbon feed to hydrodynamic cavitation to crack at least a portion of the hydrocarbon molecules present in the hydrocarbon feed and thereby produce a cavitated hydrocarbon feed; and feeding at least a portion of the cavitated hydrocarbon feed to a coker.

Paragraph B—The method of Paragraph A, wherein the hydrocarbon feed comprises a residual oil, the residual oil accounting for at least 50 wt % of the hydrocarbon feed.

Paragraph C—The method of Paragraph B, wherein the residual oil accounts for at least 80 wt % of the hydrocarbon feed.

Paragraph D—The method of any of Paragraphs A-C, wherein when the hydrocarbon feed is subjected to hydrodynamic cavitation, a portion of the hydrocarbons in the hydrocarbon feed are converted to lower molecular weight hydrocarbons.

Paragraph E—The method of any of Paragraphs A-D wherein 1 to 35 wt % of a 1050+OF boiling point fraction of the hydrocarbon feed are converted to lower molecular weight hydrocarbons.

Paragraph F—The method of any of Paragraphs A-E, wherein the hydrocarbon feed has a T95 of at least 1000° F.

Paragraph G—The method of any of Paragraphs A-F, wherein the hydrocarbon feed is subjected to a pressure drop of at least 400 psig, or more preferably greater than 1000 psig, or even more preferably greater than 2000 psig when subjected to hydrodynamic cavitation.

Paragraph H—The method of any of Paragraphs A-G, wherein the cavitated hydrocarbon feed is fed to a coker product fractionator before the at least a portion of the cavitated hydrocarbon feed is fed to the coker.

Paragraph I—The method of any of Paragraphs A-H, wherein a product of the coker is fed to a coker product fractionator at a first injection location, and wherein at least a portion of the cavitated hydrocarbon feed is fed to the coker product fractionator at a second injection location above the first injection location.

Paragraph J—The method of any of Paragraphs A-I, wherein the hydrocarbon feed comprises a residual oil feed such as a vacuum resid or an atmospheric resid.

Paragraph K—The method of any of Paragraphs A-I, wherein the hydrocarbon feed comprises a residual oil feed such as a bottoms feed from a coker product fractionator.

Paragraph L—The method of any of Paragraphs A-K, wherein the cavitated hydrocarbon feed is fed to a scrubber of a fluid coker.

Paragraph M—The method of any of Paragraphs A-L, wherein the cavitated hydrocarbon feed is sprayed into a fluidized bed in a reactor section of a fluid coker.

Paragraph N—The method of any of Paragraphs A-M, wherein a higher total liquid yield is obtained from the hydrocarbon feed than without subjecting the hydrocarbon feed to hydrodynamic cavitation.

Paragraph O—The method of any of Paragraphs A-N, wherein the portion of the cavitated hydrocarbon feed that is fed to the coker has a higher CCR content than the hydrocarbon feed.

Paragraph P—The method of any of Paragraphs A-O, wherein the hydrodynamic cavitation is performed in the absence of a catalyst.

Paragraph Q—The method of any of Paragraphs A-P, wherein the hydrodynamic cavitation is performed in the absence of a hydrogen containing gas or wherein a hydrogen containing gas is present in the hydrocarbon feed at less than 50 standard cubic feet per barrel.

Paragraph R—The method of any of Paragraphs A-Q, wherein the hydrodynamic cavitation is performed in the absence of a diluent oil.

Paragraph S—The method of any of Paragraphs A-R, wherein one or more products from the coker are upgraded by distillation, hydroprocessing, hydrocracking, fluidized cat cracking, partial oxidation, gasification, deasphalting, sweetening, oligomerization, or combinations thereof.

Paragraph T—A system adapted to perform any of the methods of Paragraphs A-S.

Paragraph U—A system for coking a hydrocarbon feed comprising a hydrodynamic cavitation unit adapted to receive a hydrocarbon feed and subject the hydrocarbon feed to hydrodynamic cavitation to crack at least a portion of the hydrocarbon molecules present in the hydrocarbon feed and thereby produce a cavitated hydrocarbon feed; and a coker downstream of the hydrodynamic cavitation unit configured to receive at least a portion of the cavitated hydrocarbon feed.

Paragraph V—The system of Paragraphs T or U, further comprising a coker product fractionator configured to receive a cracked product stream from the coker and fractionate the cracked product streams into a plurality of streams.

Paragraph W—The system of any of Paragraphs T-V, wherein the cavitated hydrocarbon feed is fed to the coker product fractionator before the at least a portion the cavitated feed is fed to the coker.

Paragraph X—The system of any of Paragraphs T-W, wherein the hydrocarbon feed comprises a bottoms product from the coker product fractionator.

Paragraph Y—The system of any of Paragraphs T-X wherein the coker is a delayed coker or a fluid coker.

### Example One

A 50/50 by volume blend of Alaska North Slope and South Louisiana vacuum resid (“feed”) was subjected to delayed coking and a partial conversion step followed by delayed coking. Properties of the feed blend are in Table 1 below.

TABLE 1
Physical Physical properties of feed hydrocarbon

| | |
|---|---|
| Specific Gravity at 76° F. | 0.9965 |
| CCR, wt % | 13.81 |
| n-heptane asphaltenes, wt % | 5.36 |
| Viscosity at 210° F., cSt | 1307 |
| Viscosity at 275° F., cSt | 175 |
| Carbon, wt % | 85.9 |
| Hydrogen, wt % | 10.6 |
| Sulfur, wt % | 2.05 |
| Nitrogen, wppm | 4885 |
| Wt % boiling < 1050° F. | 15 |
| Wt % boiling > 1050° F. | 85 |

Feed was subjected to visbreaking conditions at 115 equivalent seconds of severity at 875° F. to produce a partially converted feed. The partially converted feed approximates the effects of hydrodynamic cavitation. The partially converted feed was then fractionated to remove the material boiling below 650° F. The material boiling above 650° F. from the partially converted feed was then subjected to delayed coking. Table 2 shows the overall product yields for the process. Table 2 also provides comparative data for the feed being subjected only to delayed coking.

TABLE 5
Product yields on a wt % of fresh feed basis

| | Delayed | Visbreaking followed |
|---|---|---|
| | Coking | by Delayed Coking |
| C₄- gas | 13.2 | 8.8 |
| C₅-430° F. | 17.3 | 17.2 |
| 430-650° F. | 20.6 | 24.6 |
| 650° F.+ | 23.8 | 22.4 |
| C₅+ liquid | 61.7 | 64.2 |
| Coke | 25.1 | 27.0 |
| Total | 100.0 | 100.0 |

As shown by Table 2, the liquid yield on a wt % of fresh feed basis increased by 2.5% by partially converting feed prior to fractionation and delayed coking.

What is claimed is:

1. A method of coking comprising:
subjecting a hydrocarbon feed to hydrodynamic cavitation to crack at least a portion of the hydrocarbon molecules present in the hydrocarbon feed and thereby produce a cavitated hydrocarbon feed; and
feeding at least a portion of the cavitated hydrocarbon feed to a coker.

2. The method of claim 1, wherein the hydrocarbon feed comprises a residual oil, the residual oil accounting for at least 50 wt % of the hydrocarbon feed.

3. The method of claim 2, wherein the residual oil accounts for at least 80 wt % of the hydrocarbon feed.

4. The method of claim 1, wherein when the hydrocarbon feed is subjected to hydrodynamic cavitation, a portion of the hydrocarbons in the hydrocarbon feed are converted to lower molecular weight hydrocarbons.

5. The method of claim 4, wherein 1 to 35 wt % of a 1050+° F. boiling point fraction of the hydrocarbon feed are converted to lower molecular weight hydrocarbons.

6. The method of claim 1, wherein the hydrocarbon feed has a T95 of at least 1000° F.

7. The method of claim 1, wherein the hydrocarbon feed is subjected to a pressure drop of at least 400 psig when subjected to hydrodynamic cavitation.

8. The method of claim 7, wherein the pressure drop is greater than 1000 psig.

9. The method of claim 8, wherein the pressure drop is greater than 2000 psig.

10. The method of claim 1, wherein the cavitated hydrocarbon feed is fed to a coker product fractionator before at least a portion of the cavitated hydrocarbon feed is fed to the coker.

11. The method of claim 1, wherein the cavitated hydrocarbon feed is fed to a single stage flash unit wherein a vapor stream is separated from a liquid stream and the liquid stream is fed to the coker.

12. The method of claim 1, wherein a product of the coker is fed to a coker product fractionator at a first injection location, and wherein at least a portion of the cavitated hydrocarbon feed is fed to the coker product fractionator at a second injection location above the first injection location.

13. The method of claim 2, wherein the residual oil feed is a vacuum resid or an atmospheric resid.

14. The method of claim 2, wherein the residual oil feed is a bottoms feed from a coker product fractionator.

15. The method of claim 1, wherein the cavitated hydrocarbon feed is fed to a scrubber of a fluid coker.

16. The method of claim 1, wherein the cavitated hydrocarbon feed is sprayed into a fluidized bed in a reactor section of a fluid coker.

17. The method of claim 1, wherein a higher total liquid yield is obtained from the hydrocarbon feed than without subjecting the hydrocarbon feed to hydrodynamic cavitation.

18. The method of claim 1, wherein the portion of the cavitated hydrocarbon feed that is fed to the coker has a higher CCR content than the hydrocarbon feed.

19. The method of claim 1, wherein the hydrodynamic cavitation is performed in the absence of a catalyst.

20. The method of claim 1, wherein the hydrodynamic cavitation is performed in the absence of a hydrogen gas or wherein hydrogen gas is present in the hydrocarbon feed at less than 50 standard cubic feet per barrel.

21. The method of claim 1, wherein the hydrodynamic cavitation is performed in the absence of a diluent oil.

22. The method of claim 1, wherein one or more products from the coker are upgraded by distillation, hydroprocessing, hydrocracking, fluidized cat cracking, partial oxidation, gasification, deasphalting, sweetening, oligomerization, or combinations thereof.

23. A system for coking a hydrocarbon feed comprising
a hydrodynamic cavitation unit adapted to receive a hydrocarbon feed and subject the hydrocarbon feed to hydrodynamic cavitation to crack at least a portion of the hydrocarbon molecules present in the hydrocarbon feed and thereby produce a cavitated hydrocarbon feed; and
a coker downstream of the hydrodynamic cavitation unit configured to receive at least a portion of the cavitated hydrocarbon feed.

24. The system of claim 23, further comprising a coker product fractionator configured to receive a cracked product stream from the coker and fractionate the cracked product streams into a plurality of streams.

25. The system of claim 24, wherein the cavitated hydrocarbon feed is fed to the coker product fractionator before the at least a portion the cavitated feed is fed to the coker.

26. The system of claim 24, wherein the hydrocarbon feed comprises a bottoms product from the coker product fractionator.

27. The system of claim 23, wherein the coker is a delayed coker.

28. The system of claim 23, wherein the coker is a fluid coker.
